(19) United States
(12) Patent Application Publication
(10) Pub. No.: US 2020/0257224 A1
(43) Pub. Date: Aug. 13, 2020

(54) Additionally Cooling a Heating Device After Reaching an Erasable Toner Fixing Temperture From Either an Erasing Temperature or an Ineasable Toning Fixing Temperture

(71) Applicant: TOSHIBA TEC KABUSHIKI KAISHA, Tokyo (JP)

(72) Inventor: Hiroshi Ishii, Mishima Shizuoka (JP)

(21) Appl. No.: 16/273,284

(22) Filed: Feb. 12, 2019

(51) Int. Cl. G03G 15/20; G03G 21/20

(52) U.S. Cl. CPC G03G 15/2039; G03G 15/2053; G03G 21/206

(57) ABSTRACT

According to one embodiment, a heating device, a cooling device, a temperature sensor, and a control device are provided. A heating device operates in a first operation mode in which a first toner transferred to a medium at a predetermined first temperature is heated, or in a second operation mode in which an image formed in the medium by the first toner is heated at a second temperature higher than the first temperature. The cooling device reduces the temperature of the heating device from an operation range in the second operation mode to an operation range in the first operation mode. The temperature sensor detects the temperature of the heating device. The control device controls the cooling device to reduce the temperature of the heating device. After the temperature of the heating device detected by the temperature sensor reaches the operation range in the first operation mode, the control device further cools down the heating device based on a cooling time taken until the temperature reaches the operation range in the first operation mode from the operation range in the second operation mode.

### FIELD

Embodiments described herein relate to an image forming device.

### BACKGROUND

There is a known toner (hereinafter, referred to as “erasable toner”) which is transferred to a paper sheet and heated at a predetermined temperature (hereinafter, referred to as “fixing temperature”) to form a specific color of image, and heated at a temperature (hereinafter, referred to as “erase temperature”) higher than the temperature at the time of fixing to remove the image. In addition, there is also known a paper type of image forming device which uses the toner.

Further, there is known a hybrid image forming device having a function of forming an image using a general toner (hereinafter, referred to as “inerasable toner”) which is not removed of its color even being heated. In the hybrid image forming device, the fixing temperature of the erasable toner is lower than the fixing temperature of the inerasable toner. Therefore, when an image formed with the inerasable toner after forming the image with the inerasable toner, there is a need to cool down the inside of a fixing device.

However, even though the inside of the fixing device is cooled down by a predetermined constant time or cooled down until a predetermined temperature is detected, it cannot be said that the inside of the fixing device becomes a temperature suitable to the image formation with the inerasable toner. Therefore, in such a case, there is a concern of a defect that the image is partially erased when the image is formed with the erasable toner.

### BRIEF DESCRIPTION OF THE DRAWINGS

FIG. 1 is a diagram illustrating a configuration of a hybrid image forming device according to an embodiment;

FIG. 2 is a diagram illustrating a configuration of an image forming unit;

FIG. 3 is a diagram illustrating a configuration of a fixing device;

FIG. 4 is a block diagram of a control system of the image forming device;

FIG. 5 is a diagram illustrating a configuration of a control program;

FIG. 6 is a table illustrating cooling time information used by a heating control device when the image forming device is shifted from operation modes 2 and 3 to an operation mode 1;

FIG. 7 is a diagram illustrating a paper feed section and a non-paper feed section which are generated in a heat roller;

FIG. 8 is a flowchart illustrating the entire process of the control program; and

FIG. 9 is a flowchart illustrating the process of Act 18.

### DETAILED DESCRIPTION

In general, according to one embodiment, a heating device, a cooling device, a temperature sensor, and a control device are provided. The heating device operates in a first operation mode in which a first toner transferred to a medium at a predetermined first temperature is heated, or in a second operation mode in which an image formed in the medium by the first toner is heated at a second temperature higher than the first temperature. The cooling device reduces the temperature of the heating device from an operation range in the second operation mode to an operation range in the first operation mode. The temperature sensor detects the temperature of the heating device. The control device controls the cooling device to reduce the temperature of the heating device. After the temperature of the heating device detected by the temperature sensor reaches the operation range in the first operation mode, the control device further cools down the heating device based on a cooling time taken until the temperature reaches the operation range in the first operation mode from the operation range in the second operation mode.

Hereinafter, a first embodiment will be described in detail with reference to the drawings. The explanation will be given in an XYZ coordinate system where X, Y, and Z axes are perpendicular to each other. In the embodiments and the drawings, the same components and the processes will be attached with the same symbol. In addition, in the embodiments and the drawings, the components and wirings not essential in the description of the embodiment will be appropriately omitted.

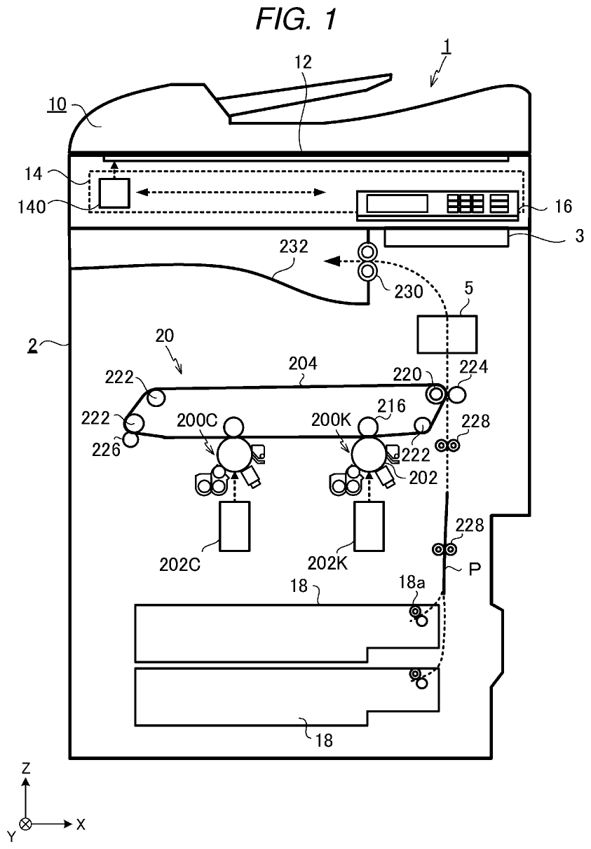

FIG. 1 is a diagram schematically illustrating a configuration of an image forming device 1 according to the embodiment. The image forming device 1 is, for example, a multi-function peripherals (MFP). The image forming device 1 forms an image to be printed in a paper sheet P according to a print command from a user.

The image forming device 1 includes a main body 2, a control device 3, and an automatic document feeder (ADF) 10 which is disposed on the upper side of the main body 2. A document table 12 made of transparent glass is disposed in the upper portion of the main body 2. The automatic document feeder (ADF) 10 is provided on the upper surface side of the document table 12 to be pivoted. In addition, an operation panel 16 is provided in the upper portion of the main body 2. The operation panel 16 includes various keys, displays an image for a GUI (Graphical User Interface), and receives a user's operation on the various keys and the image for the GUI.

A scanner 14 is provided on the lower side of the document table 12 to read an original document. The scanner 14 reads the original document sent by the automatic document feeder 10 or the original document placed in the document table 12 to generate image data. The scanner 14 includes an image sensor 140.

When reading an image of the original document placed in the document table 12, the image sensor 140 reads the image of the original document while moving in the +X direction along the document table 12. In addition, when the image of the original document supplied to the document table 12 by the automatic document feeder 10 is read, the image sensor 140 fixes the original document at a position illustrated in FIG. 1, and sequentially reads the image of the sent original document.

An image forming unit 20 is disposed in the inside of the main body 2. The image forming unit 20 forms the image obtained by rendering the image data input from the scanner 14 or a personal computer in the recording medium such as the paper sheet which is stored in a sheet cassette 18.

The image forming unit 20 includes an image forming unit 200K which forms a latent image using the inerasable toner of Black (K), an image forming unit 200C which forms the latent image using an erasable toner of Cyan (C), scanning heads 202K and 202C which are provided in correspondence with the image forming units 200K and 200C, and an intermediate transfer belt 204.

The image forming units 200K and 200C are disposed on the lower side of the intermediate transfer belt 204. In the image forming unit 20, the image forming units 200K and 200C are disposed from the +X side to the −X side. The scanning heads 202K and 202C each are disposed on the lower side of the image forming units 200K and 200C.

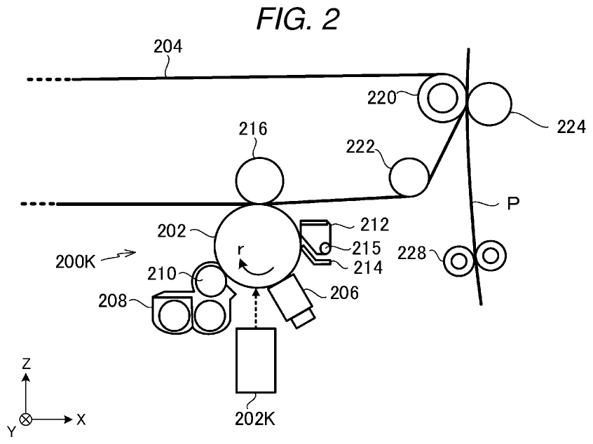

FIG. 2 is a diagram illustrating the image forming unit 200K among the image forming units 200K and 200C on an enlarged scale . The image forming units 200K and 200C have an equivalent configuration. Therefore, the image forming unit 200K will be described for describing the configuration of each image forming unit.

The image forming unit 200K includes a photosensitive drum 202 of an image bearing member. An electrification charger 206, a developing unit 208, a cleaner 212, and a primary transfer roller 216 are disposed around the photosensitive drum 202 along a direction indicated with arrow r.

At an exposure position of the photosensitive drum 202, a laser beam is emitted from the scanning head 202C. An electrostatic latent image is formed in the surface of the photosensitive drum 202 by emitting the laser beam to the surface of the rotating photosensitive drum 202.

The electrification charger 206 of the image forming unit 200K evenly charges the surface of the photosensitive drum 202. The developing unit 208 supplies the erasable toner to the photosensitive drum 202 by a developing roller 210 to which a developing bias is applied, and develops the electrostatic latent image. The cleaner 212 scraps off the inerasable toner (the erasable toner depending on the cleaner 212 of the image forming unit 200C) in the surface of the photosensitive drum 202 using the tip end of a blade 214.

The inerasable toner (the erasable toner depending on the blade 214 of the image forming unit 200C) scraped off by the tip end of the blade 214 is conveyed in the +Y axis direction by an auger 215.

As illustrated in FIG. 1, the intermediate transfer belt 204 is suspended on a driving roller 220 and three driven rollers 222. The intermediate transfer belt 204 rotates left in FIG. 1 as the driving roller 220 rotates. In addition, as illustrated in FIG. 1, the intermediate transfer belt 204 abuts on the upper surfaces of the photosensitive drums 202 of the image forming units 200K and 200K.

At a position facing the photosensitive drum 202 of the intermediate transfer belt 204, a primary transfer voltage is applied by the primary transfer roller 216. With this configuration, a toner image developed in the surface of the photosensitive drum 202 is primarily transferred to the intermediate transfer belt 204.

A secondary transfer roller 224 is disposed to face the driving roller 220 on which the intermediate transfer belt 204 is suspended. A secondary transfer voltage is applied to the paper sheet P by the secondary transfer roller 224 when the paper sheet P passes between the driving roller 220 and the secondary transfer roller 224. With this configuration, the toner image formed in the intermediate transfer belt 204 is secondarily transferred to the paper sheet P.

A belt cleaner 226 is provided adjacent to the driven roller 222 of the intermediate transfer belt 204 as illustrated in FIG. 1. The residual toner of the surface of the intermediate transfer belt 204 is removed by the belt cleaner 226.

As illustrated in FIG. 1, a sheet feeding roller 228 is provided between the sheet cassette 18 and the secondary transfer roller 224. The paper sheet P taken out from the sheet cassette 18 by a pickup roller 180 disposed adjacent to the sheet cassette 18 is conveyed between the intermediate transfer belt 204 and the secondary transfer roller 224 by the sheet feeding roller 228.

A fixing device 5 is provided on the upper side of the secondary transfer roller 224. In addition, a paper discharge roller 230 is provided on the upper side of the fixing device 5. The paper sheet P passing between the intermediate transfer belt 204 and the secondary transfer roller 224 is heated in the fixing device 5. The paper sheet P passed through the fixing device 5 is discharged to a sheet tray 232 by the paper discharge roller 230.

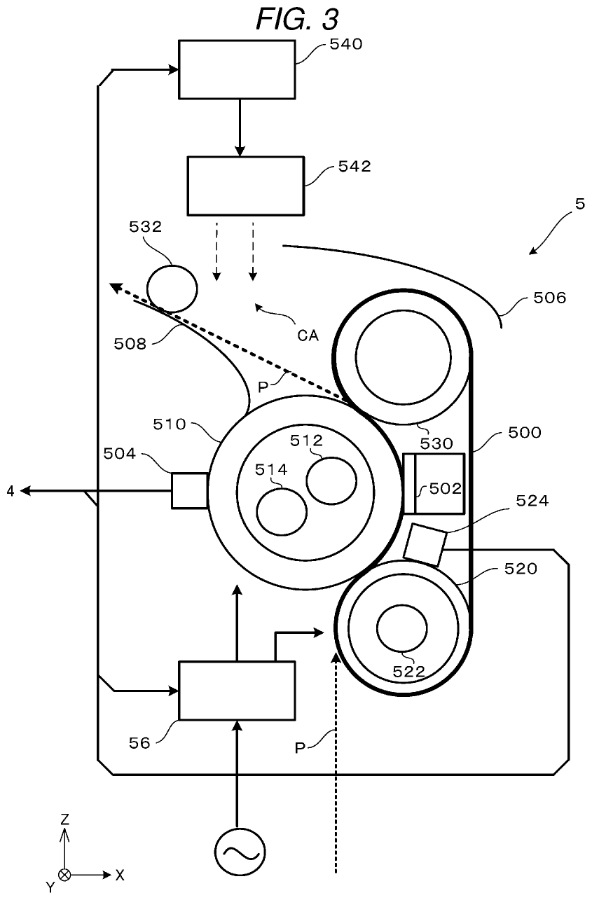

FIG. 3 is a diagram illustrating a configuration of the fixing device 5. As illustrated in FIG. 3, the fixing device 5 includes a fixing belt 500, a nip pad 502, temperature sensors 504 and 524, a sheet discharge guide 506, a conveyance guide 508, a heat roller 510, an inside heater lamp 512 and an outside heater lamp 514 which are disposed in the heat roller 510, a fixing belt roller 520, a heater lamp 522 which is disposed in the fixing belt roller 520, an output roller 530, a conveyance roller 532, a cooling control device 540, a cooling device 542, and a heating control device 56.

As illustrated with a dotted arrow, in the fixing device 5, the paper sheet P is supplied between the fixing belt 500 and the heat roller 510 from the lower side (−Z side), and the paper sheet P is discharged from the conveyance roller 532 to the upper side (+Z side).

The fixing device 5 fixes the erasable toner or the inerasable toner which is transferred to the supplied paper sheet P, or heats the paper sheet P with an erasable toner image to erase the color so as to erase the image.

The temperature sensors 504 and 524 detect the temperatures of the heat roller 510 and the fixing belt roller 520, and output the signals indicating the detected temperatures to the control device 3.

The heating control device 56 controls power to be supplied to the heater lamps 512 and 514 according to a control signal which is input from the control device 3, and controls the temperatures at which the heater lamps 512 and 514 heat the heat roller 510. In addition, the heating control device 56 controls a value of power to be supplied to the heat lamp 522 according to the control signal which is input from the control device 3, and controls the temperature at which the heater lamp 522 heats the fixing belt roller 520.

The heater lamps 512 and 514 each are 600-Watt halogen lamps, and are heat sources of the heat roller 510. The heater lamps 512 and 514 receive power from a commercial power source through the heating control device 56 and are heated to heat the heat roller 510. The heater lamp 522 is a 300-Watt halogen lamp, and is a heat source of the fixing belt roller 520. The heater lamp 522 receives power from the commercial power source through the heating control device 56 similarly to the heater lamps 512 and 514 and is heated to heat the fixing belt roller 520.

The heat roller 510 heated by the heater lamps 512 and 514 heats one surface of the paper sheet P. The fixing belt roller 520 heated by the heater lamp 522 heats the fixing belt 500. Further, the heated fixing belt 500 heats the other surface of the paper sheet P.

The nip pad 502 is configured by bonding silicon rubber and an auxiliary metal plate. The nip pad 502 is brought into press contact with an independent pressing mechanism (not illustrated) in the direction (−X direction) of the heat roller 510 from the inside of the fixing belt 500. With this configuration, the fixing belt 500 and the paper sheet P sent in the upper direction (+Z direction) in FIG. 3 come into press contact with each other in the direction (−X direction) of the heat roller 510.

The erasable toner or the inerasable toner transferred to the paper sheet P is heated by the heat roller 510 and the fixing belt 500, and fixed to the paper sheet P. Alternatively, the image of the erasable toner formed in the paper sheet P is erased. In addition, the heat roller 510 rotates in the left direction in FIG. 3, and the fixing belt roller 520 rotates in the right direction in FIG. 3 so as to send the fixing belt 500 in the right turning direction in FIG. 3.

In the fixing device 5, the erasable toner transferred to the paper sheet P is heated at a temperature about 100° C. from the heat roller 510, and heated at a temperature of about 90° C. from the fixing belt roller 520 so as to be fixed to the paper sheet P. Hereinafter, the fixing of the erasable toner to the paper sheet P is described in the image forming device 1 and in the fixing device 5 as an operation mode 1.

In the fixing device 5, the erasable toner image formed in the paper sheet P is heated at a temperature of about 120° C. from the heat roller 510 and the fixing belt roller 520 and is erased. Hereinafter, the erasing of the erasable toner image formed in the paper sheet P is described in the image forming device 1 and an operation mode 2 in the fixing device 5.

In the fixing device 5, the inerasable toner transferred to the paper sheet P is heated at a temperature of 100 to 140° C. from the heat roller 510, and heated at a temperature of 70 to 100° C. from the fixing belt roller 520 so as to be fixed to the paper sheet P. Hereinafter, the fixing of the inerasable toner image formed in the paper sheet P is described in the image forming device 1 and an operation mode 3 in the fixing device 5.

The cooling device 542 is a blower which rotates blades (not illustrated) at a speed according to the control of the cooling control device 540, and generates a cool air CA at strength and a time length which are appropriate to shifting the fixing device 5 from the operation modes 2 and 3 to the operation mode 1. The cooling device 542 supplies the cool air CA generated by the cooling device 542 to the inside of the fixing device 5 to cool the fixing belt 500, the heat roller 510, the fixing belt roller 520, and the output roller 530 in the fixing device 5.

The cooling control device 540 controls the cooling device 542 according to the signal from the control device 3, and causes the cooling device 542 to generate the cool air CA at strength and a time length which are appropriate to shifting the fixing device 5 from the operation modes 2 and 3 to the operation mode 1.

In addition, the cooling control device 540 controls the cooling device 542 during a period when the fixing device 5 is operated in the operation modes 1 to 3, and cools the paper sheet P discharged through the conveyance roller 532 at strength designated by a manufacturer. With this configuration, it is possible to prevent a failure (sticking) in which the paper sheets P discharged from the fixing device 5 to the sheet tray 232 adhere to each other by the erasable toner in the sheet tray 232.

The output roller 530 together with the heat roller 510 and the fixing belt roller 520 is suspended by the fixing belt 500, rotates in the right direction in FIG. 3, and sends the paper sheet P in the direction of the conveyance roller 532. Further, the heat roller 510, the fixing belt roller 520, and the output roller 530 keep rotating during a period when the image forming device 1 forms or erases the image. In addition, at least during a period when the mode starts to be shifted from the operation modes 2 and 3 to the operation mode 1 of the fixing device 5, the heat roller 510, the fixing belt roller 520, and the output roller 530 start to rotate for the cooling, and the fixing belt 500 is continuously sent.

The conveyance roller 532 rotates in the right direction in FIG. 3 to send the paper sheet P in the direction of the sheet tray 232 (FIG. 1).

The sheet discharge guide 506 and the conveyance guide 508 guide the paper sheet P in the direction of the paper discharge roller 230.

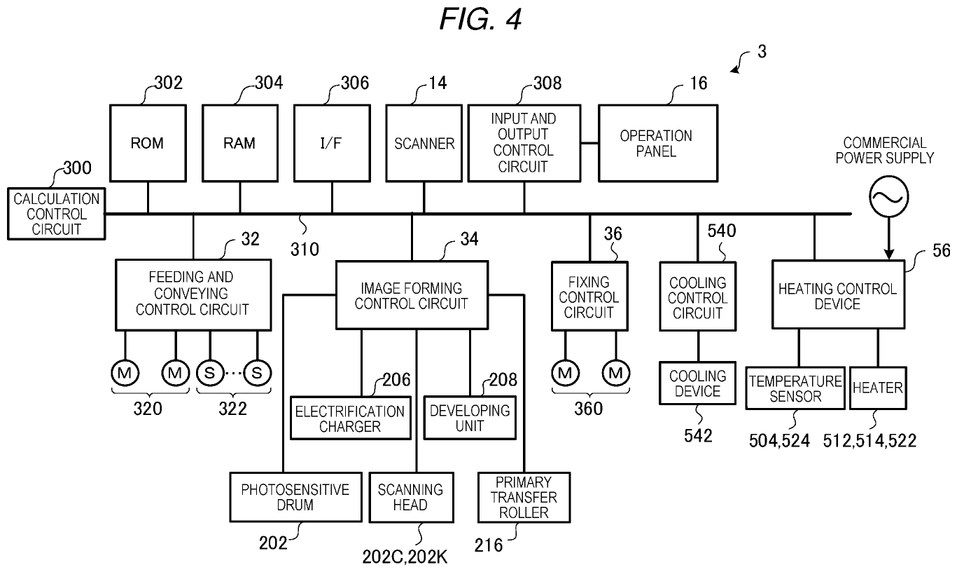

FIG. 4 is a block diagram of a control system of the image forming device 1. The control system includes the control device 3, and the control device 3 controls the entire operations of the image forming device 1. As illustrated in FIG. 4, the control device 3 is configured by a computer which includes a calculation control circuit 300 configured by peripheral circuits such as a CPU and a timer circuit, a bus line 310, a read only memory (ROM) 302, a random access memory (RAM) 304, an interface 306, and an input and output control circuit 308. The components of the control device 3 are connected through the bus line 310. Further, the control system includes a feeding and conveying control circuit 32 and an image forming control circuit 34.

The ROM 302 stores a control program and control data to control the operations of the power supply to the heater lamps 512, 514, and 522 by the heating control device 56 and the image formation including the cooling of the fixing device 5 by the cooling control device 540 and the cooling device 542.

The RAM 304 serves as a working memory which is a work area of the calculation control circuit 300.

The calculation control circuit 300 performs the program stored in the ROM 302. With this configuration, the control device 3 collectively controls the respective components, and sequentially performs the processes of the operation modes 1 to 3 in the image forming device 1 and of the other operation modes such as a facsimile transmission.

The interface 306 communicates with a terminal device of the user and a network (not illustrated). The input and output control circuit 308 displays an image for the GUI in the operation panel 16, and receives a user's input from the operation panel 16. The user of the image forming device 1 operates the operation panel 16 to designate the operation modes 1 to 3 or the other operation modes, and designate the size, the number, and the type of the paper sheet P.

The feeding and conveying control circuit 32 controls a motor group 320 which drives the pickup roller 180, the sheet feeding roller 228, or the paper discharge roller 230 of the conveyance path based on the control signal from the control device 3. The feeding and conveying control circuit 32 controls the motor group 320 according to a detection result of various types of sensors 322 provided near the sheet cassette 18 or in the conveyance path based on the control signal from the calculation control circuit 300.

The image forming control circuit 34 controls the photosensitive drum 202, the electrification charger 206, the scanning heads 202C and 202K, the developing unit 208, and the primary transfer roller 216 based on the control signal from the control device 3.

A fixing control circuit 36 controls the drive motor group 360 which drives the heat roller 510, the fixing belt roller 520, and the output roller 530 of the fixing device 5 based on the control signal from the control device 3.

Hereinafter, the process for the operation modes 1 and 3 in the image forming device 1 will be described. As needed, the cooling control device 540 controls the cooling device 542, and cools the inside of the fixing device 5. When an image is formed in the operation mode 1, as illustrated in FIG. 1, the paper sheet P is drawn from the sheet cassette 18 by the pickup roller 180, and conveyed between the intermediate transfer belt 204 and the secondary transfer roller 224 by the sheet feeding roller 228.

In the operation mode 1, the erasable toner image is formed in the photosensitive drum 202 in the image forming unit 200C in parallel with the above operation. The erasable toner images formed in the photosensitive drums 202 of the respective image forming units 200C are sequentially transferred to the intermediate transfer belt 204. With this configuration, the erasable toner image of Cyan (C) is formed in the intermediate transfer belt 204.

In the operation mode 3, the inerasable toner image is formed in the photosensitive drum 202 in the image forming unit 200K in parallel with the above operation. The inerasable toner images formed in the photosensitive drums 202 of the respective image forming units 200K are sequentially transferred to the intermediate transfer belt 204. With this configuration, the inerasable toner image of Black (K) is formed in the intermediate transfer belt 204.

When the paper sheet P conveyed between the intermediate transfer belt 204 and the secondary transfer roller 224 passes through the intermediate transfer belt 204 and the secondary transfer roller 224, the toner image formed in the intermediate transfer belt 204 is transferred to the paper sheet P.

The paper sheet P with the toner image formed passes through the fixing device 5 (FIGS. 1 and 3). At this time, the heating control device 56 (FIGS. 3 and 4) controls the supplying of power from the commercial power source to the heater lamps 512, 514, and 522 such that the temperatures of the heat roller 510 and the fixing belt roller 520 detected by the temperature sensors 504 and 524 approach the setting values of erase temperatures or fixing temperatures of the heat roller 510 and the fixing belt roller 520 in any of the operation modes 1 and 3. As a result, the paper sheet P is heated at a temperature suitable to any one of the operation modes 1 and 3 in the fixing device 5, and the erasable toner or the inerasable toner is fixed to the paper sheet P so as to form an image.

Hereinafter, the process of the operation mode 2 in the image forming device 1 will be described. The image forming device 1 pulls out the paper sheet P with the erasable toner formed from the sheet cassette 18 by the pickup roller 180, and conveys the paper sheet P to the fixing device 5.

The heating control device 56 (FIGS. 3 and 4) controls the supplying of power from the commercial power source to the heater lamps 512, 514, and 522 such that the temperatures of the heat roller 510 and the fixing belt roller 520 detected by the temperature sensors 504 and 524 approach the setting values of the fixing temperatures in the operation mode 2.

After the heat roller 510 and the fixing belt roller 520 become the temperatures suitable to the operation mode 2, the paper sheet P is conveyed to the fixing device 5, and passes therethrough. As a result, an image formed in the paper sheet P by the erasable toner is erased.

Hereinafter, the description will be given about a control program 62 which is performed by the control device 3 of the image forming device 1 (FIGS. 1 and 4) to control the operation of the image forming device 1. A command code of the control program 62 described below is supplied through a network (not illustrated) such as the Internet connected to the image forming device 1. The control program 62 is stored in the ROM 302, and performed using an OS (Operating System) such as Android or ITRON (Industrial TRON (The Real-time Operating System Nucleus)) by the calculation control circuit 300.

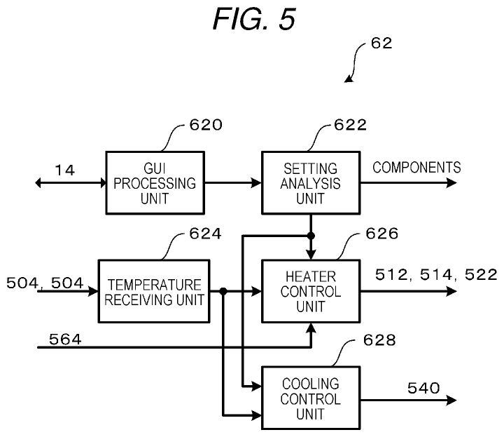

FIG. 5 is a diagram illustrating a configuration of the control program 62. As illustrated in FIG. 5, the control program 62 includes a GUI processing unit 620, a setting analysis unit 622, a temperature receiving unit 624, a heater control unit 626, and a cooling control unit 628. The control program 62 receives a user's setting to the operation panel 16 (FIG. 1). The control program 62 controls the components of the image forming device 1 according to the received setting to perform the process for the operation modes 1 to 3 and the other modes.

The GUI processing unit 620 displays an image (not illustrated) for the GUI in the operation panel 16 for the user, and receives an operation on the displayed GUI image as a user's setting on the image forming device 1 from the operation panel 16. The GUI processing unit 620 outputs the received user's setting to the setting analysis unit 622.

The setting analysis unit 622 analyzes the content of the user's setting, and determines which of the operation modes 1 to 3 and the other operation modes the user tries to make the image forming device 1 perform. The setting analysis unit 622 controls the respective components of the image forming device 1 based on the determination result to make the image forming device 1 perform the operation modes 1 to 3 or to make the image forming device 1 perform the other operation modes. Further, the setting analysis unit 622 outputs the determination result to the heater control unit 626 and the cooling control unit 628. Further, the determination result contains the setting values of the fixing temperatures or the erase temperatures of the heat roller 510 and the fixing belt roller 520 of each operation mode of the image forming device 1.

The temperature receiving unit 624 receives the temperature values of the heat roller 510 and the fixing belt roller 520 detected by the temperature sensors 504 and 524 (FIGS. 3 and 4), and outputs the values to the heater control unit 626 and the cooling control unit 628.

The heater control unit 626 processes the analysis result from the setting analysis unit 622, the values of the temperatures of the heat roller 510 and the fixing belt roller 520 received from the temperature sensors 504 and 524 by the temperature receiving unit 624, and the setting values of the fixing temperatures or the erase temperatures of the heat roller 510 and the fixing belt roller 520 of each operation mode. The heater control unit 626 controls the value of power supplied to each of the heater lamps 512, 514, and 522 based on the processing result, heats the heat roller 510 and the fixing belt roller 520 to be the temperatures corresponding to each operation mode.

The cooling control unit 628 causes the cooling control device 540 and the cooling device 542 to cool the heater lamps 512, 514, and 522 based on the analysis result from the setting analysis unit 622 and the values of the temperatures of the heat roller 510 and the fixing belt roller 520 received from the temperature receiving unit 624.

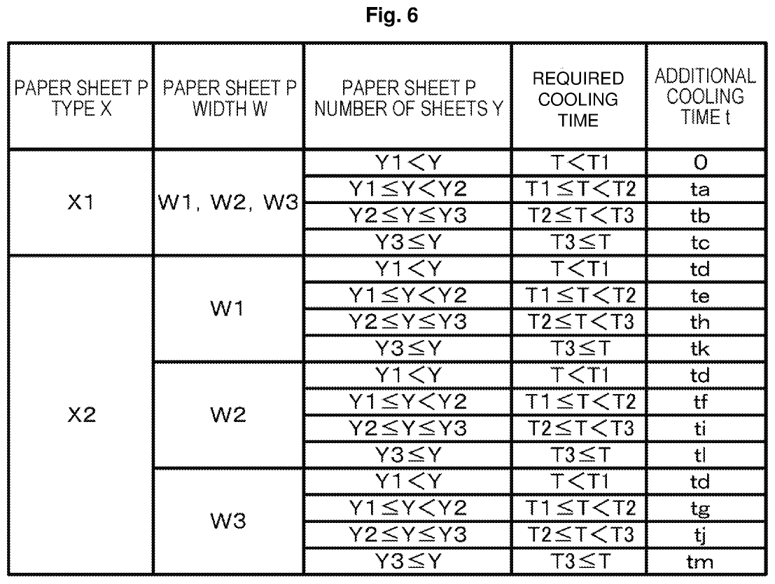

FIG. 6 is a diagram illustrating cooling time information which is used by the heating control device 56 when the image forming device 1 shifts from the operation modes 2 and 3 to the operation mode 1. As illustrated in FIG. 6, in the image forming device 1, for example, the respective widths (W) are three types W1, W2, W3 (W1<W2<W3; for example, W1=150 mm, W2=185 mm, and W3=260 mm). The paper sheet P of a type X1 in which a print speed (X) is slow (for example, a conveyance speed X1=75 mm/s), and paper sheet P of a type X2 (for example, the conveyance speed X2=225 mm/s) are used.

Even if any one of the paper sheets P of the types X1 and X2 is used in the operation modes 2 and 3, a quick cooling is first performed at a high rotation speed of the blade of the cooling device 542 (for example, 4000 rpm) when shifting to the operation mode 1. In addition, the description will be given about an additional cooling time t (any one of 0, ta, tb, tc, . . . , tm) at which the blade of the cooling device 542 is rotated at a low rotation speed (for example, 2000 rpm) to gradually cool. Further, with a slow cooling at the additional cooling time t after the quick cooling, both the heat roller 510 and the fixing belt roller 520 are appropriately cooled down to a temperature suitable to the operation mode 1.

First, when shifting from the operation modes 2 and 3 to the operation mode 1, it is measured a cooling time T taken when both temperatures of the heat roller 510 and the fixing belt roller 520 detected by the temperature sensors 504 and 524 after starting the quick cooling reaches a temperature suitable to the image formation with the erasable toner (for example, 100° C.).

The cooling time T is compared with required cooling times T1, T2, T3 (T1<T2<T3; for example, T1=20 s, T2=40 s, and T3=60 s) which are the thresholds for the cooling control. According to the comparison result and the type X, the width W, and the number of copies Y (Y1<Y2<Y3), any one of an additional cooling period ta to tm is selected as the additional cooling time t.

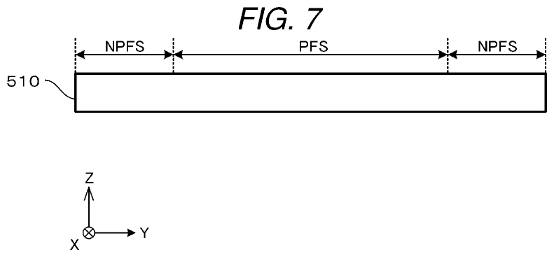

FIG. 7 is a diagram illustrating a paper feed section PFS and a non-paper feed section NPFS which are generated in the heat roller 510 (FIG. 3). Hereinafter, for example, it will be assumed that, as illustrated in FIG. 7, the paper sheet P is conveyed on the surface of the fixing belt 500 such that a central axis of the paper sheet P and the center in the width direction (Y direction) of the fixing belt 500 are matched to each other in the operation modes 2 and 3.

In this case, in a portion near the center of the fixing belt 500, the paper feed section PFS abutting on the conveyed paper sheet P and the non-paper feed section NPFS not abutting on the conveyed paper sheet P on both sides are generated. The widths of the paper feed section PFS and the non-paper feed section NPFS are changed according to the width W of the paper sheet P. In the paper feed section PFS, the heat of the heat roller 510 is taken away through the fixing belt 500 by the paper sheet P which is conveyed in this section. The heat taken away by the paper sheet P from the heat roller 510 through the fixing belt 500 in the non-paper feed section NPFS is less than that in the paper feed section PFS.

In addition, the temperature of the heat roller 510 becomes high as an operation time of the image forming device 1 in the operation modes 2 and 3 is lengthened. In other words, as the number Y of the paper sheet P is increased, the heat amount taken from the heat roller 510 in the paper feed section PFS is larger than the heat amount taken from the heat roller 510 in the non-paper feed section NPFS. In addition, if a certain number Y of the paper sheets P of the type X1 are used, the amount of heat taken away from the heat roller 510 in the paper feed section PFS is larger than the amount of heat taken away from the heat roller 510 in the non-paper feed section NPFS compared to a case where the same number Y of the paper sheets P of the type X2 are used.

With these reasons, the temperature and the temperature distribution of the heat roller 510 differ according to a combination of the number Y and the type X of the paper sheet P used in the image forming device 1 which operates in the operation modes 2 and 3. Further, in FIG. 7, as illustrated with the heat roller 510, the description of the heat roller 510 is also applied to the temperature and the temperature distribution of the fixing belt roller 520.

Further, in FIG. 6, when the measured cooling time T is less than a required cooling time T1, and the paper sheet P of the type X1 in the operation modes 2 and 3 is used, 0 (t=0 s) is selected as the additional cooling time t when the number Y of the paper sheets P is less than Y1 (for example, Y1=30) (Y<Y1) regardless of whether the width of the paper sheet P is any one of W1, W2, and W3.

In addition, similarly, when the measured cooling time T is equal to or more than the required cooling time T1 and less than T2, the number Y of the paper sheets P is equal to or more than Y1 and less than Y2 (for example, Y2=100) (Y1≤Y<Y2), a case where the additional cooling time t is ta (for example, ta=5 s) will be exemplified.

In addition, similarly, when the measured cooling time T is equal to or more than the required cooling time T2 and less than T3, the number Y of the paper sheets P is equal to or more than Y2 and less than Y3 (for example, Y3=300) (Y2≤Y<Y3), tb (for example, tb=10 s) is selected as the additional cooling time t.

In addition, similarly, when the measured cooling time T is equal to or more than the required cooling time T3, and the number Y of the paper sheets P is equal to or more than Y3 (Y3≤Y), tc (for example, tc=20 s) is selected as the additional cooling time t.

In addition, in FIG. 6, when the measured cooling time T is less than the required cooling time T1, and the paper sheet P of the type X2 in the operation modes 2 and 3 is used, td (for example, td=10 s) is selected as the additional cooling time t when the number Y of the paper sheets P is less than Y1 regardless of whether the width of the paper sheet P is any one of W1, W2, and W3.

In addition, similarly, when the measured cooling time T is equal to or more that the required cooling time T1 and less than T2, and the number Y of the paper sheets P is equal to or more than Y1 and less than Y2, any one of te, tf, and tg (for example, te=10 s, tf=20 s, and tg=30 s) is selected as the additional cooling time t according to the widths W1, W2, and W3 of the paper sheet P.

In addition, similarly, when the measured cooling time T is equal to or more than the required cooling time T2 and less than T3, and the number Y of the paper sheets P is equal to or more than Y2 or less than Y3, any one of th, ti, and tj (for example, th=20 s, ti=30 s, and tj=40 s) is selected as the additional cooling time t according to the widths W1, W2, and W3 of the paper sheet P.

In addition, similarly, when the measured cooling time T is equal to or more than the required cooling time T3, and the number Y3 of the paper sheets P is equal to or more than Y3, any one of tk, tl, and tm (for example, tk=30 s, tl=40 s, and tm=50 s) is selected as the additional cooling time t according to the widths W1, W2, and W3 of the paper sheet P.

Further, the additional cooling time t illustrated in FIG. 6 is obtained by experiments or simulations in advance by a manufacturer of the image forming device 1, and set in the cooling control unit 628.

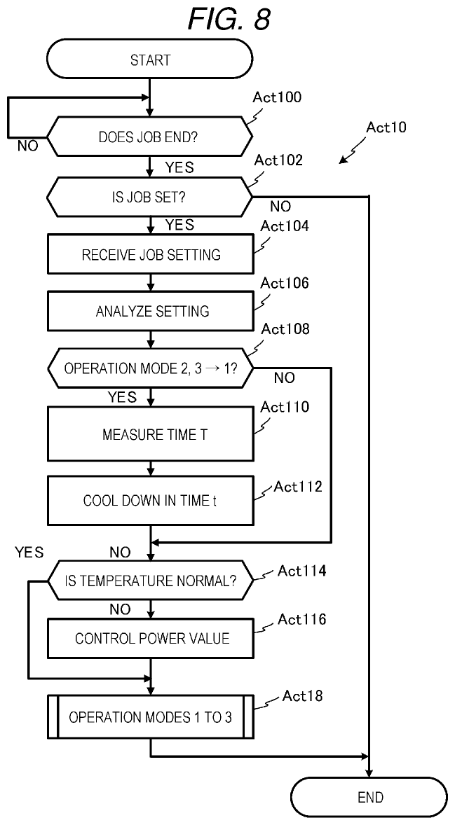

Hereinafter, the process of the control program 62 will be described. FIG. 8 is a flowchart illustrating an overall first process of Act 10 of the control program 62. As illustrated in FIG. 8, in Act 100, the setting analysis unit 622 determines whether the preceding job ends. The control program 62 proceeds to the process of Act 102 when the job ends. In the other case, the control program 62 remains in the process of Act 100.

In Act 102, the GUI processing unit 620 determines whether the operation mode and the content of a newly starting job are set in the operation panel 16. Further, in the content of the job, there is included information related to the width W, the type X, and the number Y of the paper sheets P. If a newly starting job is set (YES in the process of Act 102), the control program 62 proceeds to the process of Act 104. In the other case (NO in the process of Act 102), the control program 62 ends the process.

In Act 104, the GUI processing unit 620 outputs the operation mode and the content of the job set in the operation panel 16 to the setting analysis unit 622 and the cooling control unit 628.

In Act 106, the setting analysis unit 622 analyzes the operation mode and the content of the set job, and stores the analysis result until at least the next job ends.

In Act 108, the setting analysis unit 622 determines whether the operation mode of the job which is determined to be ended in the process of Act 100 is the operation modes 2 and 3, and whether the operation mode of the job to be performed is the operation mode 1 based on the analysis result. The control program 62 proceeds to the process of Act 110 when the job of the operation modes 2 and 3 ends and the job of the operation mode 1 starts (YES in the process of Act 108) . In other case (NO in the process of Act 108), the control program 62 proceeds to the process of Act 112.

In Act 110, the cooling control unit 628 performs the quick cooling. Further, the cooling control unit 628 measures the cooling time T taken until both the temperatures of the heat roller 510 and the fixing belt roller 520 detected by the temperature sensors 504 and 524 reach a temperature suitable to the image formation with the erasable toner after the quick cooling starts.

In Act 112, the cooling control unit 628 selects the additional cooling time t as described with reference to FIG. 6. Further, the cooling control unit 628 controls the cooling device 542, and gradually cools the inside of the fixing device 5 during the obtained additional time t and at the rotation speed corresponding to the additional time t.

In Act 114, the temperature receiving unit 624 sequentially receives the temperatures of the heat roller 510 and the fixing belt roller 520 detected by the temperature sensors 504 and 524 (FIG. 3), and outputs the temperatures to the heater control unit 626. The heater control unit 626 determines whether a difference between the detected temperatures of the heat roller 510 and the fixing belt roller 520 and the setting values of the fixing temperatures or the erase temperatures of these rollers in the operation mode of a newly starting job falls within a normal range.

For example, the determination is based on whether an absolute value of the difference is smaller than a threshold (for example, 5° C.) which is set in advance in the heater control unit 626 by a manufacturer. When the difference between the detected temperature and the setting value of the fixing temperature or the erase temperature falls within the normal range (YES in the process of Act 114), the control program 62 proceeds to the process of Act 18. In the other case (NO in the process of Act 114), the control program 62 proceeds to the process of Act 116.

In Act 116, the heater control unit 626 controls the value of power supplied from the commercial power source to the heater lamps 512, 514, and 522 such that the detected temperatures of the heat roller 510 and the fixing belt roller 520 and the setting values of the fixing temperatures or the erase temperatures of these rollers in the operation mode of the newly starting job falls within the normal range. When the difference between the detected temperature and the setting value of the fixing temperature or the erase temperature falls within the normal range, the control program 62 proceeds to the process of Act 18.

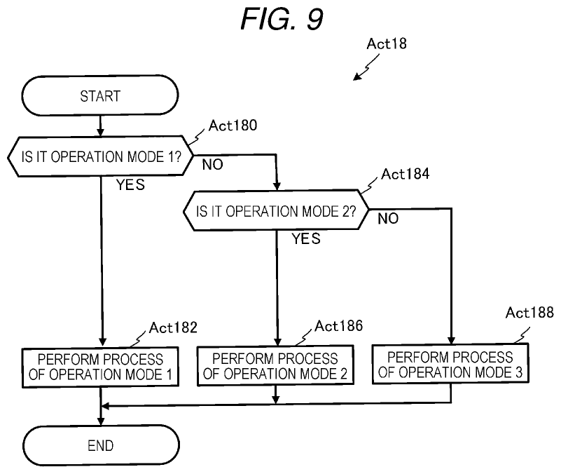

FIG. 9 is a flowchart illustrating the process of Act 18 illustrated in FIG. 8. As illustrated in FIG. 9, in Act 180, the setting analysis unit 622 determines whether a new job of the operation mode 1 will be started based on the analysis result obtained in the process of Act 106. When the job of the operation mode 1 is started (YES in the process of Act 180), the control program 62 proceeds to the process of Act 182. In other cases (NO in the process of Act 180), the control program 62 proceeds to the process of Act 184.

In Act 182, the setting analysis unit 622 controls the components of the image forming device 1 to follow the content which is set in the operation panel 16, and performs the job of the operation mode 1. When the job of the operation mode 1 ends, the control program 62 ends the process.

In Act 184, the setting analysis unit 622 determines whether a new job of the operation mode 2 will be started based on the analysis result which is obtained by the process of Act 106. When the job of the operation mode 2 is started (YES in the process of Act 184), the control program 62 proceeds to the process of Act 186. In other cases (NO in the process of Act 184), the control program 62 proceeds to the process of Act 188.

In Act 186, the setting analysis unit 622 controls the components of the image forming device 1 to follow the content which is set in the operation panel 16, and performs the job of the operation mode 2. When the job of the operation mode 2 ends, the control program 62 ends the process.

In Act 188, the setting analysis unit 622 controls the components of the image forming device 1 to follow the content which is set in the operation panel 16, and performs the job of the operation mode 3. When the job of the operation mode 3 ends, the control program 62 ends the process.

As described above, when the job of the operation mode 1 is performed immediately after the jobs of the operation modes 2 and 3 end, in the image forming device 1, the inside of the fixing device 5 is properly cooled down in consideration of the width W, the type X, and the number Y of the paper sheets P in the jobs of the operation modes 2 and 3 as illustrated with reference to FIGS. 6 to 9. Therefore, it is possible to avoid a defect which is caused when the fixing device 5 of the image forming device 1 shifts from the operation of heating the toner at a high temperature to the operation of heating the toner at a low temperature.

Further, the required cooling time or the thresholds T1 to T3 and the additional cooling times ta to tm are illustrated in FIG. 6 as an example and may be appropriately changed according to the configuration and the operations of the image forming device 1. In addition, FIGS. 6 and 8 illustrate a case where the same cooling time information is used when the image forming device 1 shifts from the operation modes 2 and 3 to the operation mode 1. However, different cooling time information may be used when the image forming device 1 shifts from the operation mode 2 to the operation mode 1, and when shifting from the operation mode 3 to the operation mode 1.

In addition to the shifting between the operation modes, the cooling described in the embodiment may be appropriately performed when there is a need to control the temperature of the inside of the fixing device 5. In addition, the fixing device 5 described in the embodiment may be a fixing device which is configured to heat the paper sheet P through a film member using a ceramic heater or an electromagnetic induction heater (IH).

In addition, FIG. 6 illustrates a case where the width W, the type X, and the number Y of the paper sheets P are set to the job. However, these setting contents may be appropriately increased or decreased according to the configuration of the fixing device 5. In addition, FIG. 6 illustrates the cooling time information which is used for the slow cooling of the additional cooling time t after the rapid cooling of the required cooling time T. However, instead of such a cooling time information, cooling time information used for the rapid cooling of the additional cooling time t after the slow cooling of the required cooling time T may be used.

In the image forming device 1, the fixing device 5 configured as illustrated in FIG. 3 is used. However, the fixing device 5 maybe replaced with a fixing device configured to include only the heat roller 510 and the fixing belt roller 520 without using the fixing belt 500. In addition, the number of the image forming units 200C and 200K is not limited to “2”, but the image forming unit 200K may be omitted, or the image forming unit 200 other than the image forming units 200C and 200K may be added.

In addition, the operation mode of the image forming device 1 may include any operation mode other than facsimile transmission. In addition, the cooling of the inside of the fixing device 5 by the cooling control unit 628 of the control program 62 may also be applied to a paper-reuse image forming device and an image forming device dedicated to the inerasable toner which needs to change the temperature of the inside of the fixing device other than a hybrid image forming device 1.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image forming device, comprising:
a heating device configured to operate in a first operation mode where a first toner transferred to a medium is heated at a first temperature or a second operation mode where an image formed in the medium by the first toner is heated at a second temperature higher than the first temperature;
a cooling device configured to decrease a temperature of the heating device from an operation range in the second operation mode to an operation range in the first operation mode;
a temperature sensor configured to detect the temperature of the heating device; and
a control device configured to control the cooling device to decrease the temperature of the heating device, wherein
after the temperature of the heating device detected by the temperature sensor reaches the operation range in the first operation mode, the control device further decreases the temperature of the heating device based on a cooling time determined in response to the temperature reaching the operation range in the first operation mode from the operation range in the second operation mode.

2. The device according to claim 1, wherein
the control device further decreases the temperature of the heating device at an additional cooling time further based on the medium being supplied to the heating device in the second operation mode, after the temperature of the heating device detected by the temperature sensor reaches the operation range in the first operation mode.

3. The device according to claim 2, wherein
the additional cooling time is further based on at least one of an amount of the medium which is supplied to the heating device and a conveyance speed of the medium to the heating device.

4. The device according to claim 1, wherein
the heating device comprises at least one heater lamp, at least one ceramic heater, or at least one electronic induction heater and the cooling device comprises a blower.

5. The device according to claim 1, wherein
the first toner is one of an erasable toner or an inerasable toner.

6. An image forming device, comprising:
a heating device configured to operate in a first operation mode where a first toner transferred to a medium is heated at a first temperature or a third operation mode where a second toner transferred to the medium is heated at a third temperature higher than the first temperature;
a cooling device configured to decrease a temperature of the heating device;
a temperature sensor configured to detect the temperature of the heating device; and
a control device configured to control the cooling device to decrease the temperature of the heating device, wherein
after the temperature of the heating device detected by the temperature sensor reaches the operation range in the first operation mode, the control device further decreases the temperature of the heating device at an additional cooling time based on a cooling time determined in response to the temperature reaching the operation range in the first operation mode from the operation range in the third operation mode.

7. The device according to claim 6, wherein
the control device further decreases the temperature of the heating device at the addition cooling time further based on the medium being supplied to the heating device in the third operation mode, after the temperature of the heating device detected by the temperature sensor reaches the operation range in the first operation mode.

8. The device according to claim 7, wherein
the additional cooling time is further based on at least one of an amount of the medium which is supplied to the heating device and a conveyance speed of the medium to the heating device.

9. The device according to claim 6, wherein
the heating device comprises at least one heater lamp, at least one ceramic heater, or at least one electronic induction heater and the cooling device comprises a blower.

10. The device according to claim 6, wherein
the first toner is one of an erasable toner or an inerasable toner.

11. An image forming device, comprising:
a heating device configured to operate in a first operation mode where a first toner transferred to a medium is heated at a first temperature, a second operation mode where an image formed in the medium by the first toner is heated at a second temperature higher than the first temperature, or a third operation mode where a second toner different from the first toner transferred to the medium is heated at a third temperature higher than the first temperature;
a cooling device configured to decrease a temperature of the heating device;
a temperature sensor configured to detect the temperature of the heating device; and
a control device configured to control the cooling device to cool down the temperature of the heating device, wherein
after the temperature of the heating device detected by the temperature sensor reaches an operation range in the first operation mode, the control device further decreases the temperature of the heating device at an additional cooling time based on a cooling time determined in response to the temperature reaching the operation range in the first operation mode from an operation range in the second operation mode or an operation range in the third operation mode.

12. The device according to claim 11, wherein
the control device further decreases the temperature of the heating device at the additional cooling time further based on the medium being supplied to the heating device in the second operation mode, after the temperature of the heating device detected by the temperature sensor reaches the operation range in the first operation mode.

13. The device according to claim 12, wherein
the additional cooling time is further based on at least one of an amount of the medium which is supplied to the heating device and a conveyance speed of the medium to the heating device.

14. The device according to claim 11, wherein
the control device further decreases the temperature of the heating device at the additional cooling time further based on the medium being supplied to the heating device in the second operation mode or the third operation mode, after the temperature of the heating device detected by the temperature sensor reaches the operation range in the first operation mode.

15. The device according to claim 14, wherein
the additional cooling time is further based on at least one of an amount of the medium which is supplied to the heating device and a conveyance speed of the medium to the heating device.

16. The device according to claim 11, wherein
the cooling device comprises a blower.

17. The device according to claim 11, wherein
the heating device comprises at least one heater lamp, at least one ceramic heater, or at least one electronic induction heater.

18. The device according to claim 11, wherein
the first toner is one of an erasable toner or an inerasable toner.

19. The device according to claim 11, wherein
the second toner is one of an erasable toner or an inerasable toner.
